(19) United States
(12) Patent Application Publication
(10) Pub. No.: US 2021/0077924 A1
(43) Pub. Date: Mar. 18, 2021

(54) LIQUID FILTER POSITIONING AND SEALING FEATURE

(71) Applicant: Caterpillar Inc., Peoria, IL (US)

(72) Inventors: Jon T. Immel, Chillicothe, IL (US); Jeffrey R. Ries, Metamora, IL (US); Javier A. Rodriguez, Peoria, IL (US)

(73) Assignee: Caterpillar Inc., Peoria, IL (US)

(21) Appl. No.: 16/569,029

(22) Filed: Sep. 12, 2019

(51) Int. Cl. B01D 29/15; B01D 35/30

(52) U.S. Cl. CPC B01D 29/15; B01D 35/30; B01D 2201/347; B01D 2201/291; B01D 2201/0415

(57) ABSTRACT

A filter element has a positioning and sealing feature including a shelf surface facing downwardly along the longitudinal axis that is spaced longitudinally away a predetermined distance from the bottom open end of the filter element.

### TECHNICAL FIELD

The present disclosure relates generally to canister style filter systems that employ a replaceable filter element. More specifically, the present disclosure relates to a filter element that includes a positioning and sealing feature for positioning the filter element axially and radially in a desired position while providing a seal that helps to ensure that dirty fluid is filtered by the filtering medium of the filter element.

### BACKGROUND

Liquid filter systems are known for filter various fluids such as gas, oil, diesel fuel, etc. to remove contaminants from these fluids. In diesel engines, for example, a fuel line filter is used to separate out water and debris from the fuel. These contaminates may accumulate in a lower portion of the filter housing (may also be referred to as a canister).

U.S. Pat. Application Publication No. 20060207948 to Hacker et al. discloses a fluid filter assembly including a housing, a service cover, a center tube removably secured to the service cover, and a filter cartridge removably sealed and circumscribing the center tube, and a seal arrangement. The seal arrangement is between the center tube and portions of the housing to close a drainage change to the flow of a clean fluid flow therethrough, when the fluid filter assembly is operating to filter the fluid.

During normal operation in Hacker, the fluid filter assembly operates to allow fluid to flow into the housing through an inlet channel, through the filter cartridge, through openings in the center tube, and out of the housing through the outlet channel. Methods for servicing include removing a service cover from a housing to remove, together with the service cover, a center tube, and open a drainage flow passageway from the housing. Next a filter cartridge is removed from the center tube, and a new filter cartridge is operably mounted on the center tube. Next, the service cover with the center tube having the new filter cartridge is operably mounted in the housing to close the drainage flow passageway.

In Hacker, methods of filtering will direct fluid to be filtered into a housing having a removable and replaceable filter cartridge; then direct the fluid through a tubular region of filter media in the cartridge; then through fluid openings in a center tube; and into a clean fluid flow passageway. Example methods include preventing fluid to bypass the filter media by removably sealing the filter cartridge to the center tube. Example methods will also include preventing fluid from flowing into a drainage passageway by removably sealing the center tube to other portions of the filter housing. Systems utilizing filter assemblies described in Hacker include fuel systems, lube systems, and hydraulic systems.

Hacker fails to disclose a feature on the center tube that may be used to both position the filter element in an adjustable manner while also providing a seal that forces dirty fluid to pass through the filter medium of the filter element before exiting the filter element.

### SUMMARY OF THE DISCLOSURE

A filter element according to an embodiment of the present disclosure may include at least a partially cylindrical configuration and that defines a longitudinal axis, and a radial direction. The filter element may comprise an annular filter media defining a central passage, a center tube that is disposed in the central passage of the annular filter media that defines a central reservoir such that the annular filter media surrounds the center tube and the central reservoir. The filter element includes a top open end joined to the center tube disposed along the longitudinal axis, the top open end including an opening allowing fluid to flow from the central reservoir to the outside of the filter element. The filter element may also include a bottom open end joined to the center tube opposite the top open end disposed along the longitudinal axis, and a positioning and sealing feature including a shelf surface facing downwardly along the longitudinal axis that is spaced longitudinally away a predetermined distance from the bottom open end.

A housing bolt for use with a canister filter system and a filter element for positioning the filter element in the canister filter system may comprise an at least partially cylindrical body defining a cylindrical axis and a radial direction. The housing bolt may also include a shoulder portion defining a shoulder portion longitudinal length. Likewise, the housing bolt may also include a shaft portion defining a shaft portion longitudinal length, and a shaft portion diameter that is less than the shoulder portion diameter, forming a support surface configured to contact a portion of the filter element. The shoulder portion further defines a top circumferential seal receiving groove spaced longitudinally away from the support surface a predetermined distance.

A canister filter system according to an embodiment may comprise a filter element that includes at least partially a cylindrical configuration and that defines a longitudinal axis, and a radial direction. The filter element may comprise an annular filter media defining a central passage, a center tube that is disposed in the central passage of the annular filter media that defines a central reservoir such that the annular filter media surrounds the center tube and the central reservoir. A top open end joined may be joined to the center tube disposed along the longitudinal axis, the top open end including an opening allowing fluid to flow from the central reservoir to the outside of the filter element, and a bottom open end joined to the center tube opposite the top open end disposed along the longitudinal axis. The canister filter system may further comprise a canister that includes a top open end, and a bottom closed end disposed along the longitudinal axis, and a housing bolt that includes a positioning and sealing structure disposed above the bottom closed end of the canister. The filter element further includes a mating feature that is configured to engage the positioning and sealing structure of the housing bolt.

### BRIEF DESCRIPTION OF THE DRAWINGS

FIG. 1 is a front sectional view of a filter assembly that includes a filter base, a canister, a filter element including a center tube with a positioning and sealing feature according to an embodiment of the present disclosure, and a housing bolt that is configured to mate with the positioning and sealing feature.

FIG. 2 is a front sectional view of the bottom portion of the filter assembly of FIG. 1 showing the mating of the housing bolt with the positioning and sealing feature of the center tube according to an embodiment of the present disclosure.

FIG. 3 is a front sectional view of the bottom portion of the filter assembly of FIG. 1 showing the mating of the housing bolt with the positioning and sealing feature of the center tube according to another embodiment of the present disclosure when it is desirable to create a chamber such as a water bowl at the bottom of the canister.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or a prime indicator such as 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters or primes will often not be included herein but may be shown in the drawings to indicate duplications of features discussed within this written specification.

First, a filter system will now be described to give the reader the proper context for understanding how various embodiments of the present disclosure are used. It is to be understood that this description is given as exemplary and not in any limiting sense. Any embodiment of an apparatus or method described herein may be used in conjunction with any filter system.

Then, a filter element that may include a center tube with a positioning and sealing feature according to various embodiments will be discussed. This feature may be located in the bottom end of a liquid filter assembly with a reusable housing (may be referred to as a canister), and it may position the filter element radially and axially in the canister (may also be referred to as the housing) while also separating the clean fluid from the dirty fluid on different sides of the filter medium via a seal. In fuel-water separators, the positioning geometry may be raised to be higher on the housing bolt to create a chamber for collecting water (i.e. a water bowl) by preventing the element from extending to the bottom of the canister.

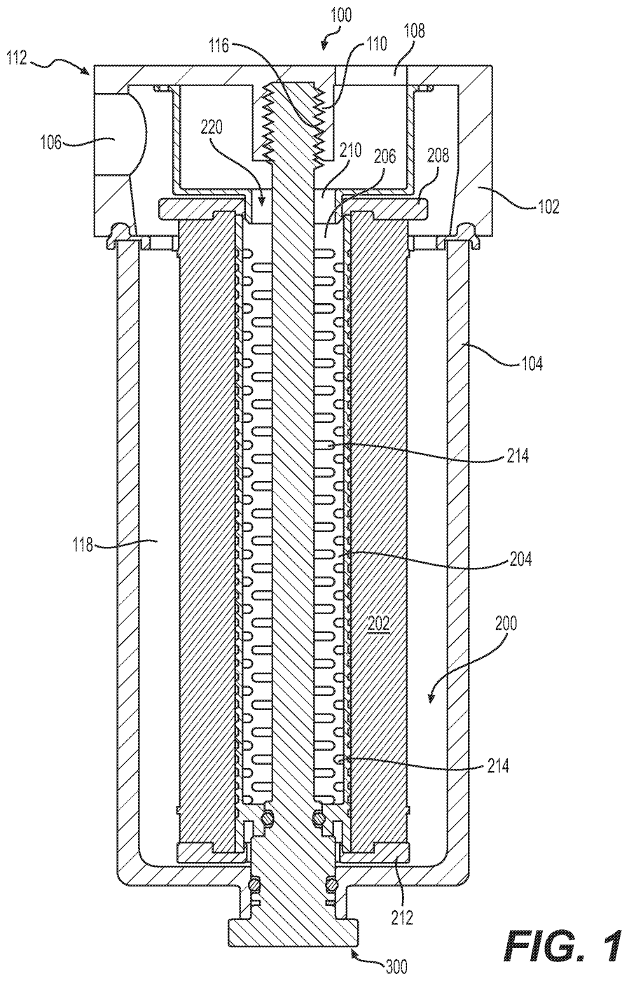

FIG. 1 illustrates a canister filter system 100 that may use a filter element 200, and a housing bolt 300 according to various embodiments of the present disclosure.

The canister filter system 100 may include having a base 102, a canister 104, a housing bolt 300, and a filter element 200. The canister filter system 100 may be used to filter fluids such as diesel or gasoline or other liquid fuels, lubrication oil, hydraulic fluid for hydraulic power systems, transmission fluid, or even possibly intake air for an engine. The canister filter system 100 may also be used as a fuel/water separator filter. The canister filter system 100 with the features described herein could be adapted by those of ordinary skill in this art to serve many different purposes and suit many other applications.

The base 102 includes an inlet channel 106 for fluid to enter into the canister filter system 100, and an outlet channel 108 for fluid to exit from the canister filter system 100. The base 102 also includes base threads 110. Other attachment structure than threads may be used.

The canister 104 includes a top open end 112 and a bottom closed end 114. Adjacent the top open end 112 are bolt threads 116 which can be engaged with base threads 110 to hold the canister 104 to base 102. Threads are one example of engagement structures which may be included on the base 102 and bolt 300 to form a releasable engagement. Other engagement structures may be used as will be recognized by those of ordinary skill in this art.

The filter element 200 may take many different forms to suit a particular application. In the illustrated embodiment, the filter element 200 is well suited for filtering fuel or lubrication oil. The filter element 200 may include annular filter media 202 circumferentially surrounding a central reservoir 204 defined by a center tube 206. Axial ends of annular filter media 202 are shown to be sealed by end caps.

A top end cap 208 may define an axial open end of filter element 200. The top end cap 208 is termed “open” because it includes an opening 210 for allowing passage of fluid to outlet channel 108 from the central reservoir 204 defined by center tube 206.

On the other hand, the bottom end cap 212 defines an axial closed end of filter element 200. The bottom end cap 212 is termed “closed” because it prevents any fluid outside the filter element 200 adjacent the axial end of the annular filter media 202 from flowing unfiltered into center tube 206.

The top end cap 208 and the bottom end cap 212 may each be joined to the center tube 206 via welding, adhesives, etc. Alternatively, several or all of center tube 206, the top end cap 208, and the bottom end cap 212 may be constructed as unitary components. Conversely, the bottom end cap 212 and/or the top end cap 208 may be separate components from the center tube 206, etc. Further details of the closed configuration of the bottom of the canister filter system 100 and the filter element 200 will be discussed later herein.

In operation, fluid to be filtered enters from the inlet channel 106 and flows to the annular cavity 118 between canister 104 and the annular filter media 202. The fluid then passes into and through filter media 202, then into the center tube 206 through the perforations 214 shown therein in FIG. 1.

Then, the fluid exits center tube 206 through the top end cap 208 and opening 210 into the outlet channel 108. The sealed construction at the bottom of the filter element 200 helps to define the fluid channels into and out of the annular filter media 202, preventing any fluid from flowing directly to outlet channel 108 and bypassing the annular filter media 202. To that end, sealing features may be provided that will be discussed in detail later herein. Moreover, it may be desirable to create a chamber (e.g. a water bowl in fuel-water separators) between the bottom of the filter element and the bottom of the canister. So, a positioning feature may be provided as will be discussed later herein.

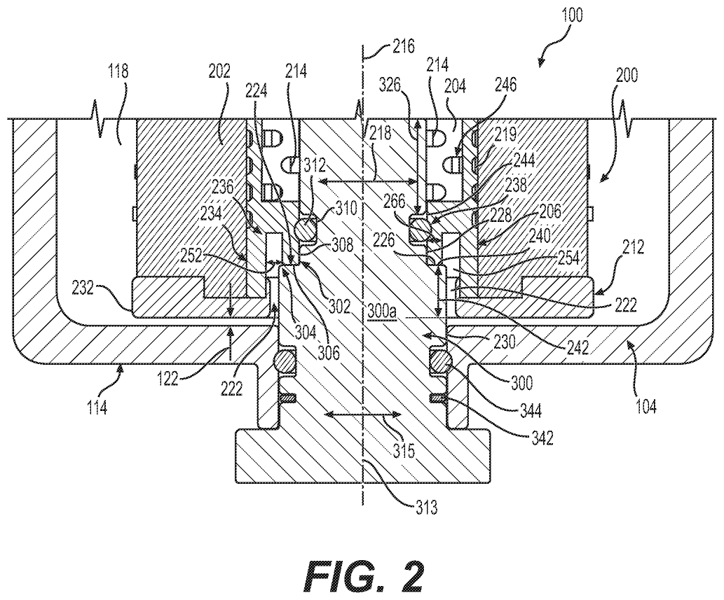

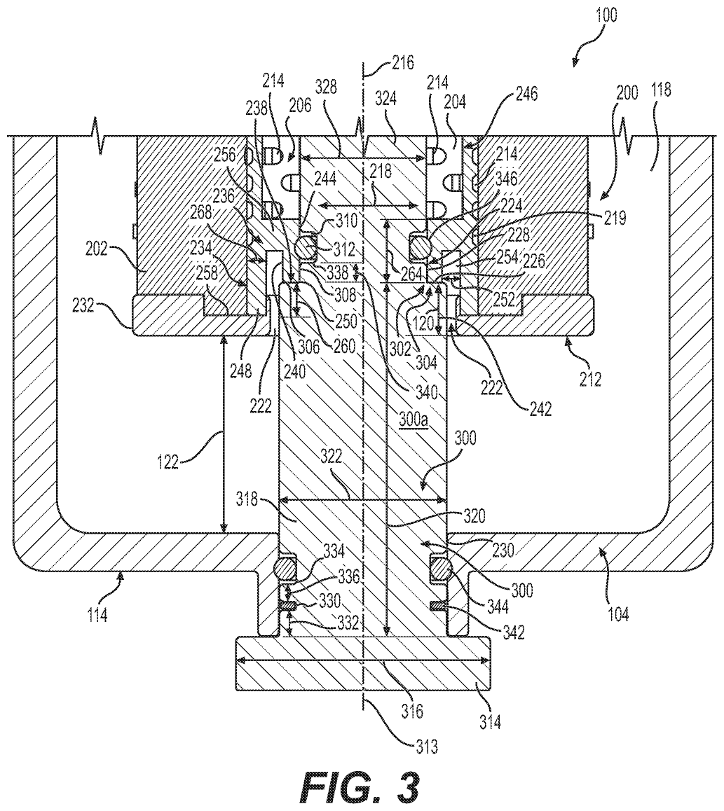

Referring now to FIGS. 2 and 3, a canister filter system 100 according to various embodiments of the present disclosure that provides sealing and positioning feature(s) will now be discussed.

The canister filter system 100 may comprise a filter element 200 that includes at least partially a cylindrical configuration and that defines a longitudinal axis 216, and a radial direction 218. The filter element 200 may comprise an annular filter media 202 defining a central passage 219 and a center tube 206 that is disposed in the central passage 219 of the annular filter media 220 that defines a central reservoir 204. Thus, the annular filter media 202 surrounds the center tube 206, and the central reservoir 204.

As best seen in FIG. 1, the filter element 200 may further include a top open end 220 joined to the center tube 206 disposed along the longitudinal axis 216. The top open end 220 includes an opening 210 that allows fluid to flow from the central reservoir 204 to the outside of the filter element 200.

Similarly, referring again to FIGS. 2 and 3, the filter element 200 may include a bottom open end 222 joined to the center tube 206 opposite the top open end 220 that is also disposed along the longitudinal axis 216. Thus the bottom open end 222 allows insertion of the housing bolt 300.

The canister filter system 100 may also include a canister 104 that includes a top open end 112 (see FIG. 1), and a bottom closed end 114 relative to the longitudinal axis 216 (as previously described herein, see FIGS. 2 and 3), and a housing bolt 300 that penetrates through the bottom closed end 114 of the canister 104. This may not be the case in other embodiments of the present disclosure. For example, a stud style bolt may be provided that rests on the bottom closed end of the canister such that its shoulder portion or its head is trapped between the filter element and the canister, etc.

The housing bolt 300 may include a positioning and sealing structure 302 disposed longitudinally above the bottom closed end 114 of the canister 104, while the filter element 200 also includes a mating feature 224 (e.g. another flat surface complimentarily shaped to match that of the housing bolt) that is configured to engage the positioning and sealing structure 302 of the housing bolt 300.

The sealing structure 302 of the housing bolt 300 may include a stepped pin portion 304 including a support surface 306 facing longitudinally upwardly, a convex cylindrical radial alignment surface 308 extending upwardly longitudinally from the rest surface 306, and a first groove 310 disposed on the convex cylindrical radial alignment surface 306 that is configured to receive a first seal 312 that may be disposed in the first groove 310.

Similarly, the mating feature 224 of the filter element 200 may include a contact surface 226 facing downwardly along the longitudinal axis 216, and a concave cylindrical surface 228 that extends upwardly from the contact surface 226 along the longitudinal axis 216.

As a result, the contact surface 226 of the filter element 200 may abut the support surface 306 of the housing bolt 300, and the concave cylindrical surface 228 may contact the first seal 312, and may be disposed radially proximate to the convex cylindrical radial alignment surface 308 (may actually touch) of the housing bolt 300. This may properly position the filter element both axially and radially while also providing a seal to keep dirty fluid from bypassing the annular filter media.

As alluded to earlier herein, the canister filter system 100 may further comprise a bottom end cap 212 that is disposed longitudinally and radially proximate to the center tube 206 and to the annular filter media 202. The bottom end cap 212 may include a thru-hole 230 that is configured to receive the center tube 206, and may define a bottom surface 232 of the bottom end cap 212 that defines the bottom open end 222 of the filter element 200.

The support surface 306 may be spaced longitudinally away from the bottom surface 232 of the bottom end cap 212 a protrusion distance 120 (so called since the housing bolt 300 protrudes into the filter element 200 by this amount) that may range to up to 25% of the filter length, and the bottom surface 232 of the bottom end cap 212 may be spaced longitudinally away from the bottom closed end 114 of the canister 104 a chamber distance 122 (so called since this forms a chamber such as a water bowl) ranging from 0 inches to 3.0 inches in some embodiments in order to obtain the desired volume in the canister.

In the embodiments shown in FIGS. 2 and 3, the mating feature 224 is formed by the center tube 206, but this may not be the case in other embodiments. If so, the center tube 206 may include a bottom portion 234 that includes a U-shaped structure 236 defined in a plane including the longitudinal axis 216, and the radial direction 218. Thus, this U-shaped structure 236 may form the contact surface 226, and the concave cylindrical surface 228. Other shaped structures may be used in other embodiments of the present disclosure.

As implied earlier herein, the filter element 200 may be concentric with the canister 104, and with the housing bolt 300. The housing bolt 300 may be attached to the canister 104, fixing the position of the housing bolt 300 relative to the canister 104.

Any of the aforementioned dimensions and configurations may be different than what has been specifically set forth herein.

Next, a filter element 200 according to various embodiments of the present disclosure that may be used with the canister filter system 100 just described will now be discussed in further detail by itself.

Looking at FIGS. 2 and 3, the filter element 200 may include at least a partially cylindrical configuration, defining a longitudinal axis 216, and a radial direction 218. The filter element 200 may comprise an annular filter media 202 defining a central passage 219. A center tube 206 may be disposed in the central passage 219 of the annular filter media 202 that defines a central reservoir 204. The annular filter media 202 may surround the center tube 206 and the central reservoir 204 (and may be concentric about the center tube and the central reservoir).

As best seen in FIG. 1, a top open end 220 may be joined to the center tube 206 that is disposed along the longitudinal axis 216. The top open end 220 may include an opening 210 that allows fluid to flow from the central reservoir 204 to the outside of the filter element 200.

In FIGS. 2 and 3, a bottom open end 222 may be joined to the center tube 206 opposite the top open end 220 that is disposed along the longitudinal axis 206. This may allow the insertion of the housing bolt 300 as previously mentioned herein.

The filter element 200 may include a positioning and sealing feature 238 including a shelf surface 240 facing downwardly along the longitudinal axis 216 that is spaced longitudinally away a predetermined distance 242 from the bottom open end 222. The positioning and sealing feature 238 may further comprise a radially inwardly facing cylindrical surface 244 that is disposed longitudinally proximate the shelf surface 240. The radially inwardly facing cylindrical surface 244 may extend upwardly longitudinally from the shelf surface 240.

The filter element 200 may further comprise a bottom end cap 212 that is disposed longitudinally and radially proximate the center tube 206, and the annular filter media 202. The bottom end cap 212 defining a thru-hole 230 that is configured to receive the center tube 206, and defines a bottom surface 232 of the bottom end cap 212 that defines the bottom open end 222 of the filter element 200. So, the predetermined distance 242 from the bottom surface 232 of the bottom end cap 212 to the shelf surface 240 may range from 0 up to 25% of the length of the filter in some embodiments.

The center tube 206 may include a bottom portion 234 that forms the shelf surface 240, and the radially inwardly facing cylindrical surface 244. The remainder portion 246 that may be disposed longitudinally above the bottom portion 234 may form perforations 214 disposed above the bottom portion 234 of the center tube 206. These perforations 214 allow fluid to pass through the annular filter media 202 and out of the filter element 200.

In some embodiments, the center tube 206 may be cast or injection molded. So, it may be desirable to maintain the nominal wall thickness of the center tube to avoid sinks or voids from forming during manufacturing.

To that end, the bottom portion 234 of the center tube 206 may include a U-shaped structure 236 that is defined in a plane including the longitudinal axis 216, and the radial direction 218 (see FIGS. 2 and 3).

As best seen in FIG. 3, the U-shaped structure 236 may face longitudinally downwardly, and may include a radially outer leg 248, a radially inner leg 250 spaced radially inwardly away from the radially outer leg 248 a spacing distance 252, forming a void 254 between the radially inner leg 250 and the radially outer leg 248. A bridge 256 connects the radially outer leg 248 to the radially inner leg 250. Hence, a thick section of material is avoided since the nominal wall thickness of the center tube remains fairly consistent. This may not be the case in other embodiments such as those that are machined from a single piece of material, those that are assembled from multiple parts, etc. In addition, this void 254 may extend completely to the bottom end cap 212 such as when the bottom end cap 212 is a separate component from the center tube 206.

The radially inner leg 250 may form the shelf surface 240, and the radially inwardly facing cylindrical surface 244. The radially outer leg 248 may define a free end 258 that is spaced longitudinally away from the shelf surface 240 a predetermined amount 260 such that the free end 258 is proximate to the bottom end cap 212.

In some embodiments, the predetermined amount 260 may range as previously mentioned, the spacing distance 252 may range from 0 to 25% of the diameter of the center tube 206, and the radially inner leg 250 defines an inner radial width 266 (see FIG. 2) ranging from 1.0 mm to 4.0 mm. The radially inner leg 250, and the bridge 256 may define a longitudinal length 264 (see FIG. 3) of the radially inwardly facing cylindrical surface 244 ranging from 5.0 mm to 15.0 mm, and the radially outer leg 248 may define an outer radial width 268 ranging from 1.0 mm to 4.0 mm.

Any of the aforementioned configurations and dimensions may be different than specified herein in other embodiments of the present disclosure.

Next, a housing bolt 300 according to various embodiments of the present disclosure that may be used with the canister filter system 100 or the filter element 200 just described for positioning the filter element in the canister filter system will now be discussed in further detail by itself.

With continued reference to FIGS. 2 and 3, the housing bolt 300 may comprise an at least partially cylindrical body 300a defining a cylindrical axis 313, and a radial direction 315. With continued reference to FIG. 3, the housing bolt 300 may include a head 314 defining a head diameter 316, a shoulder portion 318 defining a shoulder portion longitudinal length 320, and a shoulder portion diameter 322 that is less than the head diameter 316. The housing bolt 300 may further comprise a shaft portion 324 defining a shaft portion longitudinal length 326 (see FIG. 2), and a shaft portion diameter 328 that is less than the shoulder portion diameter 322, forming a support surface 306 configured to contact a portion of the filter element 200.

With continued reference to FIG. 3, the shoulder portion 318 may further define a first circumferential seal receiving groove 330 disposed longitudinally proximate to the head 314 being spaced longitudinally away from the head 314 a first distance 332, and a second circumferential seal receiving groove 334 disposed longitudinally between the first circumferential seal receiving groove 330 and the support surface 306. The second circumferential seal receiving groove 334 may be spaced longitudinally away from the first circumferential seal receiving groove 330 a second distance 336. The shaft portion 324 may further define a third circumferential seal receiving groove 338 (may also be referred to as a top circumferential seal receiving groove) that is spaced longitudinally away from the support surface 306 a third distance 340 (may also be referred to as a predetermined distance).

In some embodiments, the shoulder portion longitudinal length 320 ranges from 25.0 mm to 100.0 mm, the shoulder portion diameter 322 ranges from 15.0 mm to 40.0 mm, the head diameter 316 ranges from 25.0 mm to 50.0 mm, the shaft diameter 328 ranges from 6.0 mm to 17.0 mm, the first distance 332 ranges from 2.0 mm to 8.0 mm, the second distance 336 ranges from 2.0 mm to 8.0 mm, and the third distance 340 ranges from 2.0 mm to 10.0 mm.

In addition, a ratio of the shoulder portion longitudinal length 320 to the shoulder portion diameter 322 may range from 1.0 to 8.0 in certain embodiments of the present disclosure. Also, a ratio of the head diameter 316 to the shaft diameter 328 may range from 1.0 to 9.0 in certain embodiments of the present disclosure.

Any of these dimensions and/or ratios may be varied to be different in other embodiments of the present disclosure.

The housing bolt 300 may further comprise a contaminant seal 342 disposed in the first circumferential seal receiving groove 330, a first fluid seal 344 disposed in the second circumferential seal receiving groove 334, and a second fluid seal 346 disposed in the third circumferential seal receiving groove 338.

### INDUSTRIAL APPLICABILITY

In practice, a filter element, a housing bolt, or a canister filter system may be obtained or provided in an OEM (original equipment manufacturer) or aftermarket context. The height of the position of the filter element may be changed via changing the height of the shoulder portion of the housing blot or the corresponding features of the filter element (e.g. the center tube).

The center tube and the housing bolt may be made from any suitable material including plastic, metal, etc. It may be desirable to choose materials that are chemically compatible with the fluids being filtered.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

It will be apparent to those skilled in the art that various modifications and variations can be made to the embodiments of the apparatus and methods of assembly as discussed herein without departing from the scope or spirit of the invention(s).

Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A filter element that includes at least a partially cylindrical configuration and that defines a longitudinal axis, and a radial direction, the filter element comprising:
an annular filter media defining a central passage;
a center tube that is disposed in the central passage of the annular filter media that defines a central reservoir, and the annular filter media surrounds the center tube and the central reservoir;
a top open end joined to the center tube disposed along the longitudinal axis, the top open end including an opening allowing fluid to flow from the central reservoir to the outside of the filter element;
a bottom open end joined to the center tube opposite the top open end disposed along the longitudinal axis; and
a positioning and sealing feature including a shelf surface facing downwardly along the longitudinal axis that is spaced longitudinally away a predetermined distance from the bottom open end.

2. The filter element of claim 1 wherein the positioning and sealing feature further comprises a radially inwardly facing cylindrical surface that is disposed longitudinally proximate the shelf surface.

3. The filter element of claim 2 wherein the radially inwardly facing cylindrical surface extends upwardly longitudinally from the shelf surface.

4. The filter element of claim 3 further comprising:
a bottom end cap that is disposed longitudinally and radially proximate the center tube and the annular filter media, the bottom end cap defining a thru-hole that is configured to receive the center tube, and defining a bottom surface of the bottom end cap that defines the bottom open end of the filter element; and
wherein the center tube includes a bottom portion that forms the shelf surface and the radially inwardly facing cylindrical surface, and a remainder portion that forms perforations disposed above the bottom portion of the center tube.

5. The filter element of claim 4 wherein the bottom end cap is a separate component from the center tube.

6. The filter element of claim 4 wherein the bottom portion of the center tube includes a U-shaped structure defined in a plane including the longitudinal axis and the radial direction, the U-shaped structure facing longitudinally downwardly, the U-shaped structure including
a radially outer leg;
a radially inner leg spaced radially inwardly away from the radially outer leg a spacing distance, forming a void between the radially inner leg and the radially outer leg; and
a bridge that connects the radially outer leg to the radially inner leg.

7. The filter element of claim 6 wherein the radially inner leg forms the shelf surface and the radially inwardly facing cylindrical surface, and the radially outer leg defines a free end that is spaced longitudinally away from the shelf surface a predetermined amount such that the free end is disposed proximate to the bottom end cap.

8. The filter element of claim 7 wherein the void extends completely to the bottom end cap and the bottom end cap is a separate component from the center tube.

9. A housing bolt for use with a canister filter system and a filter element for positioning the filter element in the canister filter system, the housing bolt comprising:
an at least partially cylindrical body defining a cylindrical axis and a radial direction, and including
a shoulder portion defining a shoulder portion longitudinal length, and a shoulder portion diameter; and
a shaft portion defining a shaft portion longitudinal length, and a shaft portion diameter that is less than the shoulder portion diameter, forming a support surface configured to contact a portion of the filter element; and
the shaft portion further defines a top circumferential seal receiving groove spaced longitudinally away from the support surface a predetermined distance.

10. The housing bolt of claim 9 further comprising:
a head defining a head diameter; and
wherein the shoulder portion diameter is less than the head diameter, a ratio of the shoulder portion longitudinal length to the shoulder portion diameter ranges from 1.0 to 8.0, and a ratio of the head diameter to the shaft diameter ranges from 1.0 to 9.0.

11. The housing bolt of claim 9 wherein the shoulder portion
further defines
a first circumferential seal receiving groove disposed longitudinally proximate to the head being spaced longitudinally away from the head a first distance, and
a second circumferential seal receiving groove disposed longitudinally between the first circumferential seal receiving groove and the support surface, the second circumferential seal receiving groove being spaced longitudinally away from the first circumferential seal receiving groove a second distance; and
further comprising a contaminant seal disposed in the first circumferential seal receiving groove, a first fluid seal disposed in the second circumferential seal receiving groove, and a second fluid seal disposed in the top circumferential seal receiving groove.

12. A canister filter system comprising:
a filter element that includes at least partially a cylindrical configuration and that defines a longitudinal axis, and a radial direction, the filter element comprising:
an annular filter media defining a central passage;
a center tube that is disposed in the central passage of the annular filter media that defines a central reservoir, and the annular filter media surrounds the center tube and the central reservoir;
a top open end joined to the center tube disposed along the longitudinal axis, the top open end including an opening allowing fluid to flow from the central reservoir to the outside of the filter element; and
a bottom open end joined to the center tube opposite the top open end disposed along the longitudinal axis:
a canister that includes a top open end, and a bottom closed end disposed along the longitudinal axis; and
a housing bolt that includes a positioning and sealing structure disposed longitudinally above the bottom closed end of the canister,
wherein filter element further includes a mating feature that is configured to engage the positioning and sealing structure of the housing bolt.

13. The canister filter system of claim 12 wherein the positioning and sealing structure of the housing bolt includes a stepped pin portion including a support surface facing longitudinally upwardly, a convex cylindrical radial alignment surface extending upwardly longitudinally from the rest surface, and defining a first groove disposed on the convex cylindrical radial alignment surface that is configured to receive a first seal in the first groove.

14. The canister filter system of claim 13 wherein the mating feature of the filter element includes a contact surface facing downwardly along the longitudinal axis, and a concave cylindrical surface extend upwardly from the contact surface along the longitudinal axis.

15. The canister filter system of claim 14 further comprising a first seal disposed in the first groove and wherein the contact surface of the filter element abuts the support surface of the housing bolt, and the concave cylindrical surface contacts the first seal, and is disposed radially proximate to the convex cylindrical radial alignment surface of the housing bolt.

16. The canister filter system of claim 15 further comprising a bottom end cap that is disposed longitudinally and radially proximate to the center tube, and to the annular filter media, the bottom end cap including a thru-hole that is configured to receive the center tube, and defining a bottom surface of the bottom end cap that defines the bottom open end of the filter element.

17. The canister filter system of claim 16 wherein the bottom end cap is a separate component from the center tube.

18. The canister filter system of claim 14 wherein the mating feature is formed by the center tube.

19. The canister filter system of claim 18 wherein the center tube includes a bottom portion that includes a U-shaped structure defined in a plane including the longitudinal axis and the radial direction, the U-shaped structure forming the contact surface, and the concave cylindrical surface.

20. The canister filter system of claim 12 wherein the filter element is concentric with the canister, and with the housing bolt, the housing bolt being attached to the canister and penetrating through the bottom closed end of the canister, fixing the position of the housing bolt relative to the canister.
